(19) United States
(12) Patent Application Publication
(10) Pub. No.: US 2012/0151393 A1
(43) Pub. Date: Jun. 14, 2012

(54) MANIPULATION OF ELEMENTS AND THEIR ATTRIBUTES IN GRAPHICAL USER INTERFACES

(76) Inventor: HENRIK ARNDT, Frankfurt (DE)

(21) Appl. No.: 12/964,743

(22) Filed: Dec. 10, 2010

(51) Int. Cl. G06F 3/048

(52) U.S. Cl. 715/765

(57) ABSTRACT

Various embodiments of systems and methods for manipulation of elements and their attributes in graphical user interfaces are described herein. A graphical layout comprising nodes and connections as a representation of data in a data source is displayed on a user interface. One or more nodes of the graphical layout are rendered to graphically represent manipulation operations performed by a user on one or more nodes of the graphical layout to create a new data source. The manipulation operations comprise at least one of selection of one or more nodes, changing an attribute, and changing connections between the nodes.

### FIELD

The field relates generally to graphical user interfaces. More particularly, the field is related to manipulation of elements and their attributes in graphical user interfaces of network structures.

### BACKGROUND

Network structures of complex systems are typically represented using graphical layouts on user interfaces. Examples of such complex systems include software systems, software programs with complex structures, and data in data sources. The graphical layouts mainly include nodes and connections to represent elements of the system and relation between the elements. The elements can include items and attributes of items. Icons are used for representing nodes and sub-nodes. The connection between the nodes can be represented using lines or arrows.

Such graphical layouts may be used for navigation. A user can move nodes (e.g. to the center of the graphical layout) and expand or collapse to navigate and reach a required element. If a user needs to manipulate or edit an element in a graphical layout, a separate view is opened where editing operations are performed. These editing operations can include changing name of an item, selecting and deselecting attributes of an item, establishing connections between items and attributes, and other manipulation of an element's representation in the graphical layout. An overview of connections between the elements is useful and important for performing editing operations. The user may therefore need to switch back and forth between the separately opened view and the graphical layout. This causes a break in the interaction flow and leads to usability issues, especially in the case of large network structures.

It would therefore be desirable to provide efficient and user friendly manipulation of elements of a network structure layout.

### SUMMARY

Various embodiments of systems and methods for manipulation of elements and their attributes in graphical user interfaces are described herein. A graphical layout comprising nodes and connections as a representation of data in a data source is displayed on a user interface. Manipulation operations can be performed by a user on one or more nodes of the graphical layout to create a new data source. One or more nodes of the graphical layout are rendered to graphically represent manipulation operations. The manipulation operations comprise at least one of selection of one or more nodes, changing an attribute, and changing connections between the nodes.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating a method for manipulation of elements of a graphical layout, according to one embodiment.

FIG. 2 is a block diagram of a user interface showing a graphical layout, according to one embodiment.

FIG. 3 is a block diagram of a user interface showing a graphical layout with nodes rendered to indicate manipulation operations, according to one embodiment.

FIG. 4 is a block diagram of a user interface showing a table view of the graphical layout of FIG. 3, according to one embodiment.

FIG. 5 is a block diagram of a user interface showing an embodiment of manipulation operations on the graphical layout.

FIG. 6 is a block diagram of a user interface showing a graphical layout with nodes rearranged to represent manipulation operations of FIG. 5, according to one embodiment.

FIG. 7 is a block diagram of a user interface showing a table view of the graphical layout of FIG. 6, according to one embodiment.

FIG. 8 is a block diagram of a user interface showing a graphical layout with nodes rendered to indicate manipulation operations, according to another embodiment.

FIG. 9 is a block diagram of an exemplary computer system according to one embodiment.

### DETAILED DESCRIPTION

Embodiments of techniques for manipulation of elements and their attributes in graphical user interfaces are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

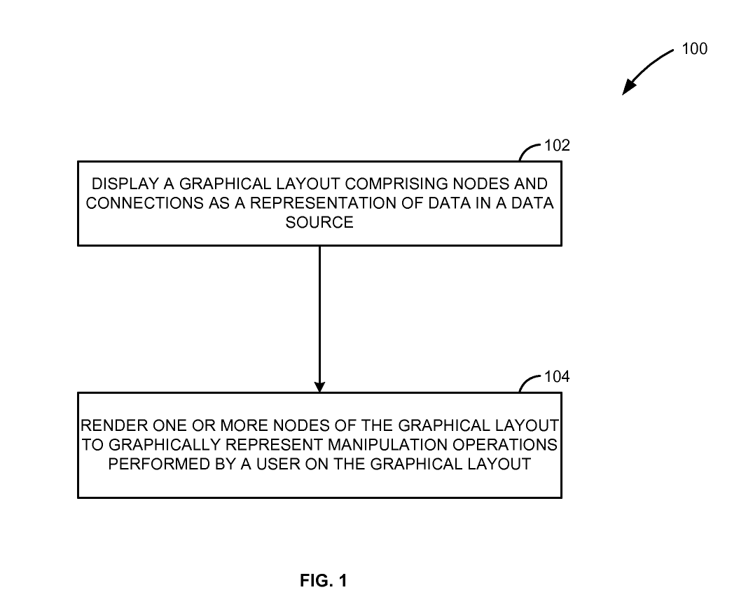

FIG. 1 illustrates an embodiment of a method for manipulation of elements of a graphical layout. In the context of this embodiment, the graphical layout is a graphical user interface that includes graphical elements in the form of nodes and connections between the nodes. The graphical layout can be a network structure that is used to represent a variety of systems including software systems using a plurality of nodes and connection. The graphical layout can include a hierarchical arrangement of nodes. Underlying data of a system or references to the data can be represented using the graphical layout. For example, a software system can include files and attributes of files. The files and attributes can be represented as nodes and the relationships between the files and the attributes can be represented using connections between the nodes. As another example, data in a data source (e.g. a database or a data warehouse) can include fields and attributes, which can also be represented as a graphical layout.

At 102, the graphical layout comprising nodes and connections as a representation of data in a data source is displayed on a user interface. A user may choose to display the graphical layout via a user interface of an application. In one embodiment, the application can be specific to enable manipulation operations on the graphical layout. In another embodiment, the application can have several other functionalities.

A user can perform manipulation operations on the graphical layout for various purposes. In one embodiment, a user may perform manipulation operations on the graphical layout for creating a new data source using a combination of elements in the data source. The user does not need to switch to any alternate view such as a list view or a table view to manipulate the elements of the graphical layout. The manipulation operations may vary depending on the underlying data that is represented by the graphical layout. The manipulation operations include node name editing operations, node selection operations, attribute change operations, and changing connections between the nodes.

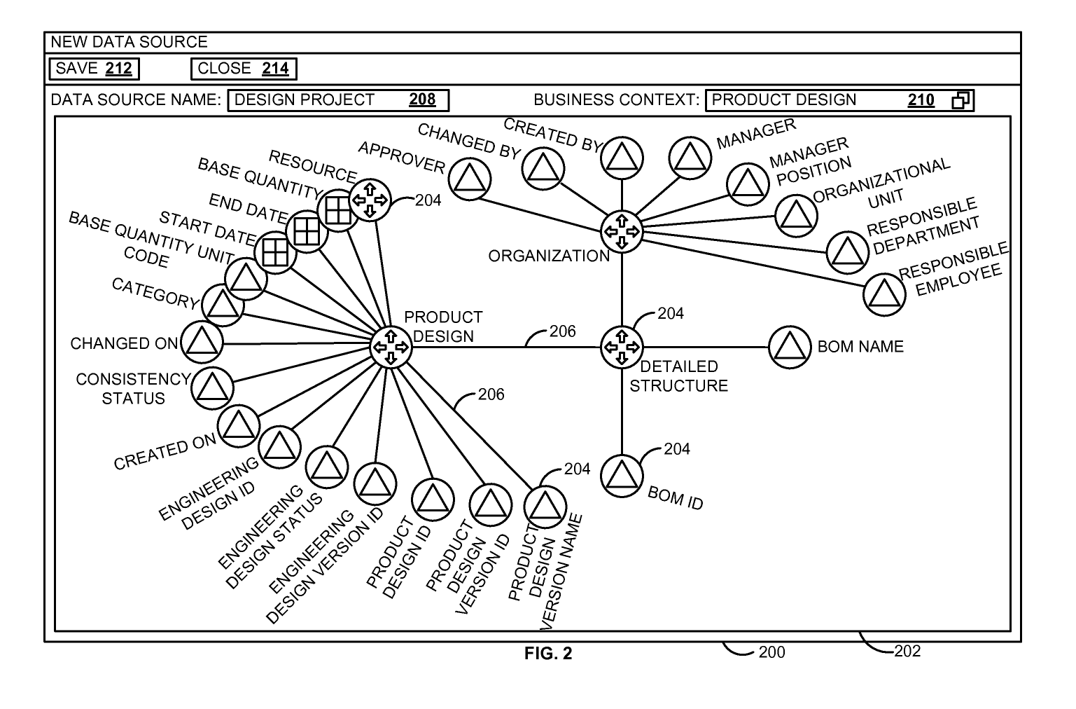

At 104, the nodes in the graphical layout are instantly rendered to graphically represent the manipulation operations performed by a user on the graphical layout. A unique graphical characteristic is assigned to each manipulation operation. The graphical characteristic can be a symbol, a color, or a combination of both symbol and color. In response to certain manipulation operations, a set of nodes are rearranged. The manipulation operations and the corresponding rendering of nodes are explained in detail with reference to FIGS. 2-8.

FIG. 2 illustrates an embodiment of a user interface 200 showing a graphical layout 202. The graphical layout 202 is a two-dimensional (flat) representation of a network. However, the method for manipulation of elements can also be applied to graphical layouts having three-dimensional representation of a network. The elements of the graphical layout 202 include nodes 204 and connections 206 between nodes 204. The graphical layout 202 represents data in a data source. In one embodiment, the data source is an info cube. In another embodiment, the data source is a multi-dimensional data source used for business analytics or business intelligence applications. The nodes 204 of the graphical layout 202 represent elements or fields in a data source. Some nodes represent a category of data source elements or fields. For example, ‘organization’ node is a category that includes the elements/fields such as “Approver,” “Changed By,” “Created By,” “Manager,” etc. The category nodes can be represented by a unique icon-symbol combination, for example, a circle encompassing arrows. The connections 206 represent the relationship between the various elements of the data source. An attribute of a node can be represented using a specific symbol within the node 204. Depending on the application that provides the graphical layout, the user interface 200 can include a data source name field 208, a context field 210, a save option 212, and a close option 212.

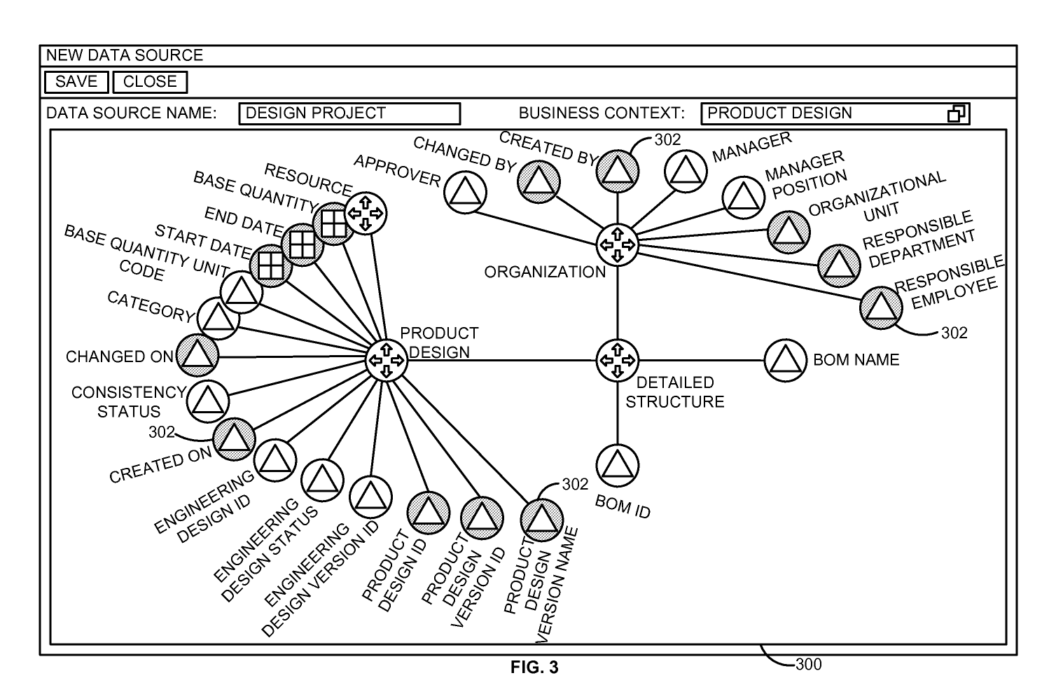

Referring to FIG. 3, the graphical layout 300 provides an overview of a data source. The manipulation operations can include selection of the nodes to make them part of a new data source. The user can select the nodes by a mouse click on the graphical layout. The selected nodes 302 are immediately rendered in the same view of the graphical layout 300 with a graphical characteristic to represent the selection operation. In one embodiment, the graphical characteristic is represented by a color coding of the selected nodes. The selected nodes are rendered with a different color compared to the non-selected nodes. The color coding is represented as gray shading in the figure, but it can be any color. A user can then save and close the graphical layout 300. The selected nodes 302 form part of the new data source that can be in turn used as the base data source on which a business analytics report can be build.

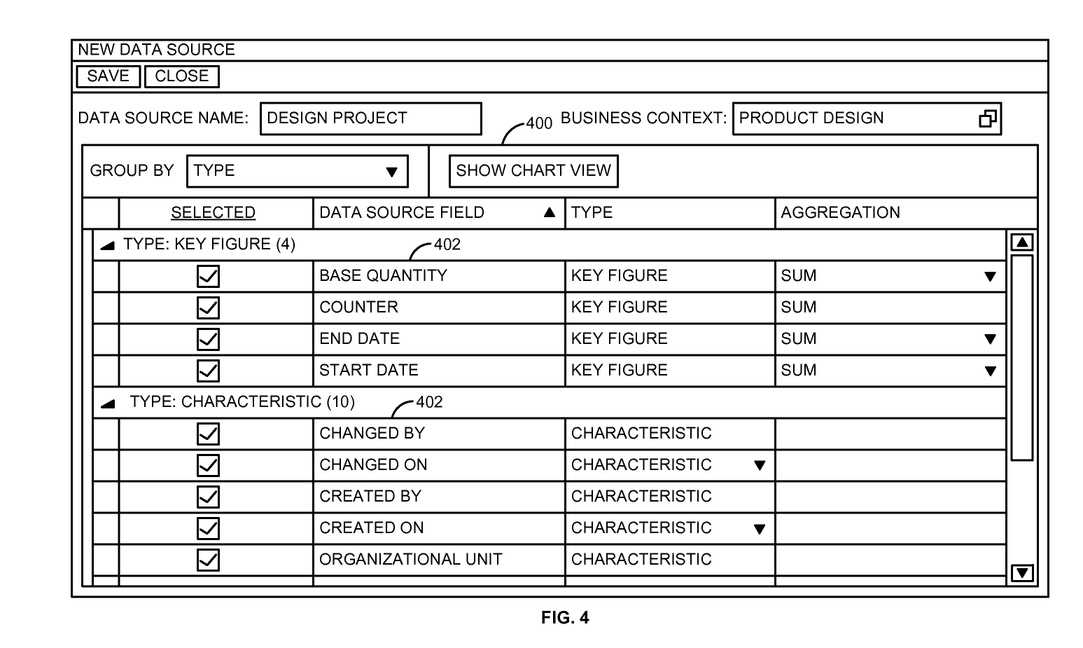

Referring to FIG. 4, the new data source selected on the graphical layout can also have a corresponding table view 400. The table view 400 provides a list 402 of selected nodes for the new data source. It can be noted that the selection operations are performed within the graphical layout (300 in FIG. 3) are reflected in the table view 400. A user does not need to switch between the graphical layout and a separate view (i.e. the table view 400) to perform the selection operations.

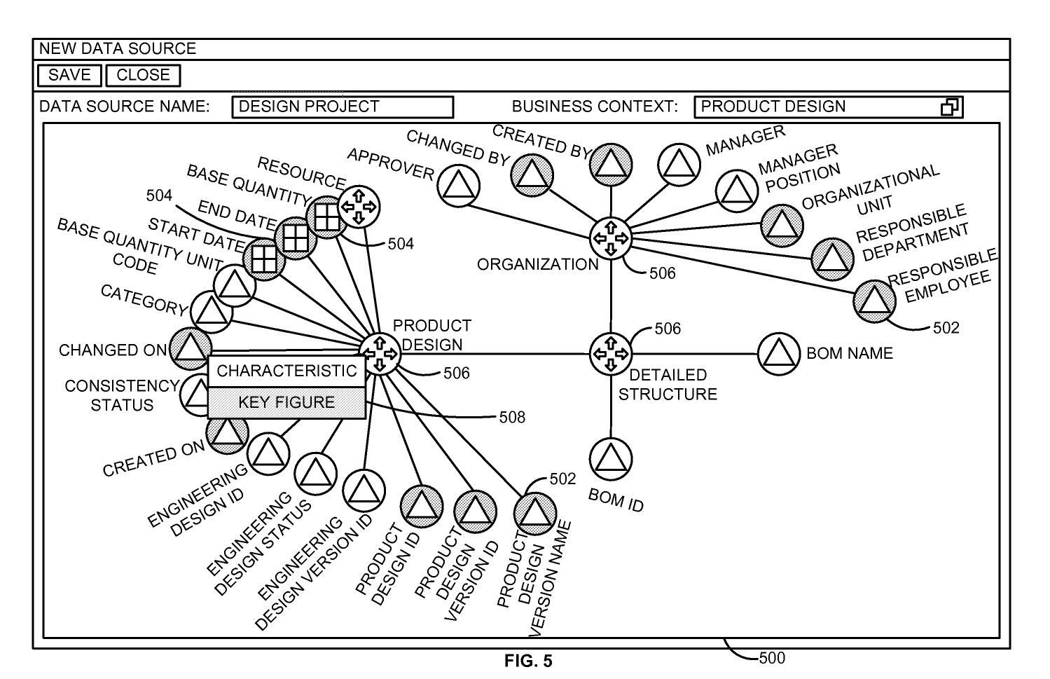

FIG. 5 illustrates an embodiment of manipulation operations performed on the graphical layout 500. The graphical layout 500 represents elements of a data source. In one embodiment, the data source is an object containing key figures and characteristics, which provides a multidimensional, analytical view of business data. Data sources are associated with a specified access context or can be unrestricted. Key figures and characteristics are fields according to which values are selected. Characteristics can be alphanumeric, numeric, or text values. Examples of characteristics include Product ID, Supplier, and Purchase Order Status. Variables can be associated with specified characteristics. Variables restrict characteristics to one or more specified value selections. Key figures are numeric values that have a unit of measure or currency assigned. Examples include Invoice Net Value and Purchase Order Quantity. A report, which is a compilation of data for analysis, shows values derived from key figures and characteristics in data sources.

Attributes of some of the nodes can include a key figure and a characteristic. For example, the lowest level of nodes can either have a “key figure” attribute or a “characteristic” attribute. The nodes with key figure attribute 502 can be represented differently compared to nodes with characteristics attribute 504. In one embodiment, a symbol inside the node can be used to differentiate between the nodes with key figure attribute 502 and the nodes with characteristics attribute 504. The nodes with key figure attribute 502 can be represented as a circle enclosing a grid symbol and nodes with characteristics attribute 504 can be represented as a circle enclosing a triangle.

A group of nodes with key figure attributes and characteristic attributes can belong to a category. This category also can be represented as a category node or a parent node. There can be several levels of category and each category can have other categories and nodes. The user can move a category node into the center of the graphical layout via a mouse click on it. Thus all sub-nodes of the category node that might have been outside the visible area of the network graph get visible and accessible. The category nodes 506 can be represented by a different icon-symbol combination, for example, a circle encompassing arrows. Also, the nodes with key figure attributes 502 and all the nodes with characteristic attributes 504 that emanate from a parent node, e.g. product design node 506, can be grouped. The nodes depending from a parent node and belonging to an attribute can be shown in a particular order. For example, nodes can be arranged in an alphabetical order by considering the node names (Base quantity node, End date node, and Start date node are arranged sequentially considering the starting alphabet of the node name).

The manipulation operations include changing the attribute of nodes, which can be performed by a user after the node selection operations or independent of the node selection operations. In one embodiment, a user can change the attributes by selecting a node, e.g. via a right click. A list 508 of available attributes can then be displayed. An attribute can then be selected. For example, a user can right click on the “changed on” node that has a characteristic attribute. A key-figure attribute and a characteristic attribute can then be displayed in the same view of the graphical layout. The user can select the key figure attribute.

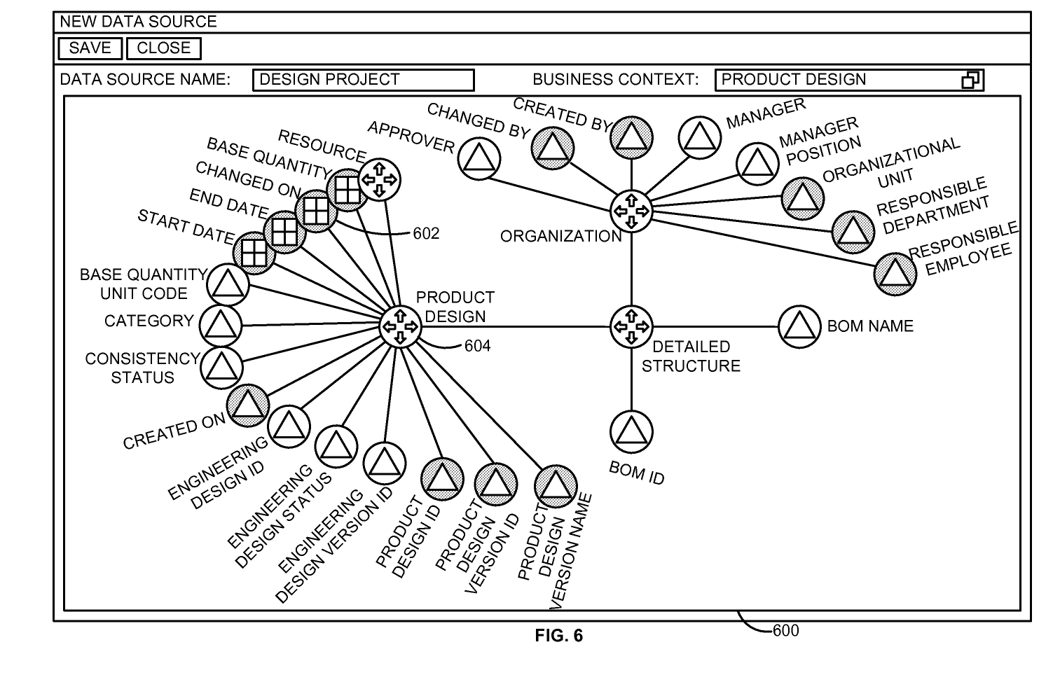

Referring to FIG. 6, after changing an attribute, the nodes are rendered in the same view of the graphical layout 600 to represent the change in attribute. For example, the “changed on” node 602 is represented as a circle enclosing a grid symbol indicating that it is now a key figure attribute. The nodes can also be rearranged to reflect the change in the attributes. Since the attribute of the “changed on” node 602 is changed to key figure, the nodes are rearranged so that the “changed on” node 602 is moved to the group of nodes with key figure attributes.

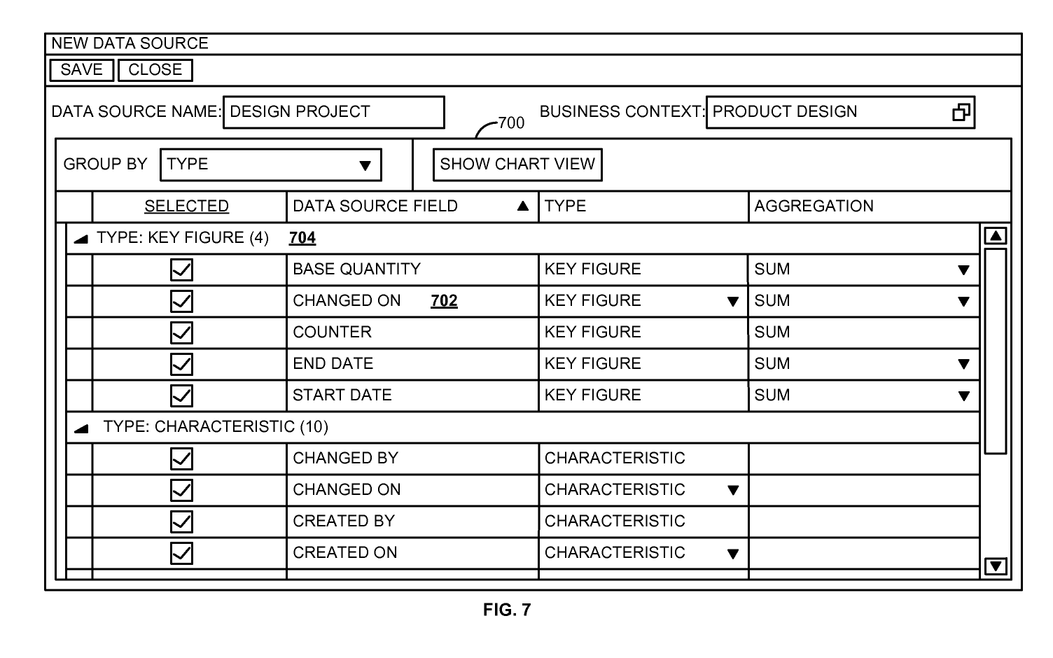

FIG. 7 illustrates an embodiment of a table view 700 of the corresponding graphical layout (600 in FIG. 6) after changing attributes. The “changed on” node 702 which was in characteristic group (as shown in FIG. 4) is now present in the key figure group 704 following the attribute change operation performed on the corresponding graphical layout.

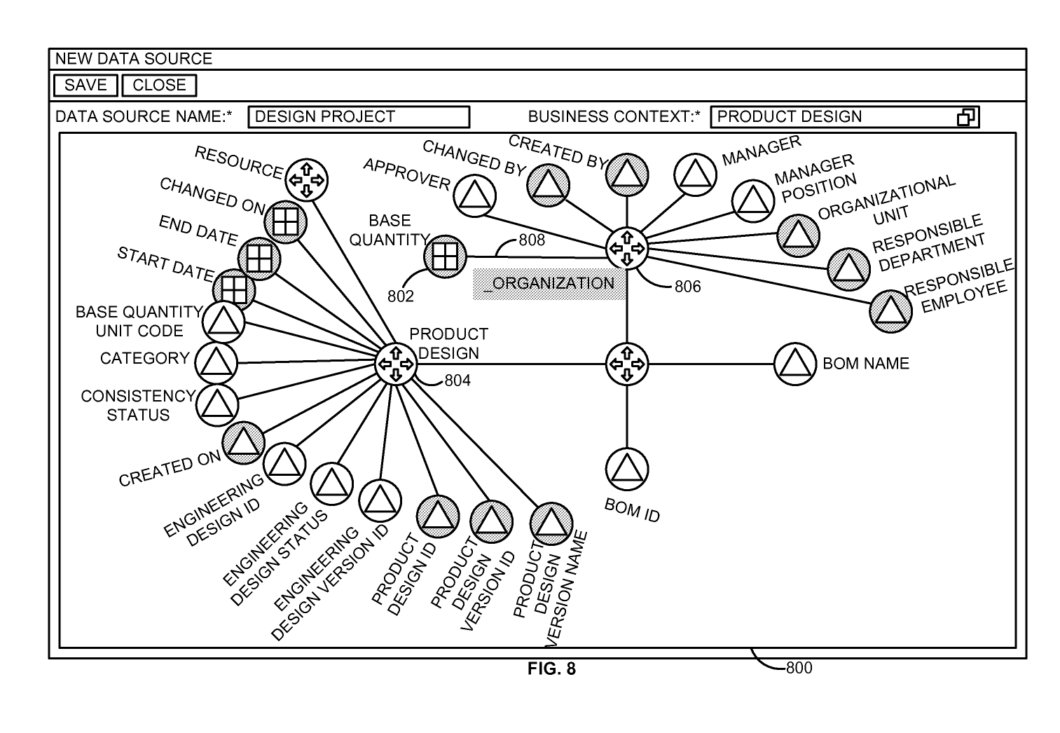

FIG. 8 illustrates a graphical layout 800 with nodes rendered to indicate another manipulation operation, i.e. changing connections between nodes. A user can drag and drop one node over another node to change connections between the nodes. In one embodiment, a new connection is established between the newly connected nodes. For example, the base quantity node 802 that was connected to the product design node 804 (as shown in FIG. 6) is dragged and dropped over the organization node 806. The base quantity node 802 is rendered to represent its connection with the organization node 806. A line 808 between the base quantity node 802 and the organization node 806 is instantly rendered to represent the connection. The old connection between the base quantity node 802 and the product design node 804 can be deleted. In another embodiment, depending on the type of attribute, node, or the underlying data, the old connections can be retained.

In another embodiment, name of a node can also be edited on the graphical layout. Names of all nodes may not be required to be edited. There may be some nodes eligible for name editing depending on the application. A user can select a name of a node (e.g. double click) for editing. In FIG. 8, for example, the name ‘organization’ is selected by a user for editing. A user need not switch to a corresponding list view or table view to edit the name.

One of the advantages of the method for manipulation of elements of a graphical layout is that a user does not need to change a view or open a separate view to perform manipulation operations. The manipulation operations are instantly represented graphically on the graphical layout with unique graphical characteristics. This enables a user to identify the manipulated nodes. A user's cognitive effort is minimized as there is no need to switch between multiple views. Also, the graphical layout represents an overview of an entire structure, which facilitates a user to perform relevant and appropriate manipulation operations.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

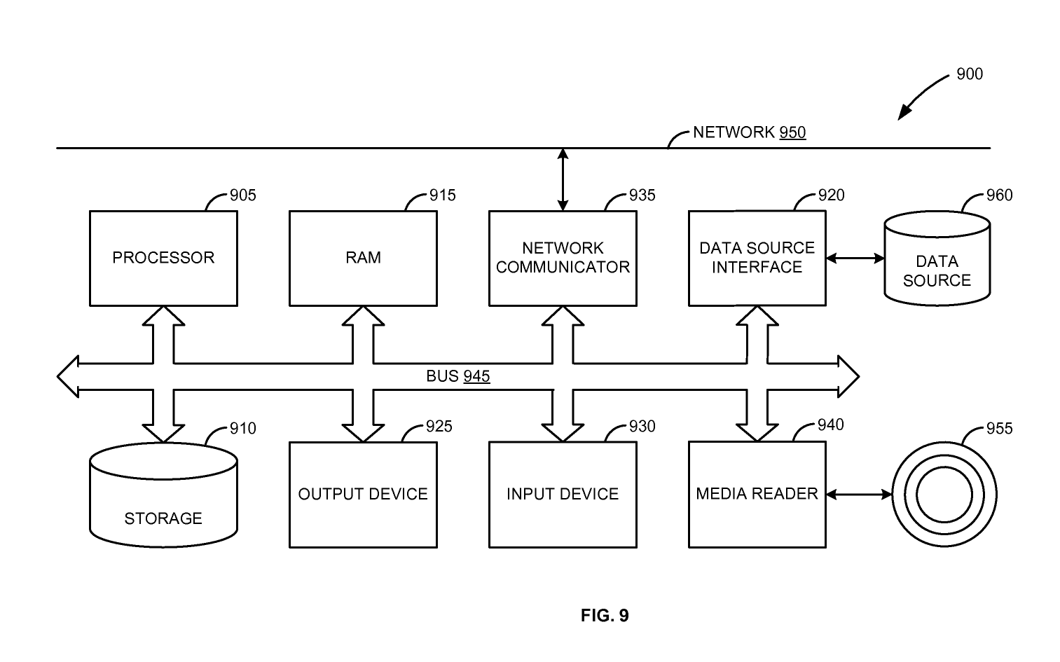

FIG. 9 is a block diagram of an exemplary computer system 900. The computer system 900 includes a processor 905 that executes software instructions or code stored on a computer readable storage medium 955 to perform the above-illustrated methods of the invention. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. The stored instructions may be further compiled to generate other representations of the instructions and dynamically stored in the RAM 915. The processor 905 reads instructions from the RAM 915 and performs actions as instructed. According to one embodiment of the invention, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
display on a user interface a graphical layout comprising nodes and connections as a representation of data in a data source; and
render one or more nodes of the graphical layout to graphically represent manipulation operations performed by a user on one or more nodes of the graphical layout to create a new data source, wherein the manipulation operations comprise at least one of:
selection of one or more nodes, changing an attribute, and changing connections between the nodes.

2. The article of manufacture of claim 1, wherein the instructions to render the one or more nodes of the graphical layout to graphically represent manipulation operations, comprise instructions to:
render the one or more nodes of the graphical layout to graphically represent the one or more manipulation operations with unique graphical characteristics represented by a color, a symbol, or a combination of the color and symbol.

3. The article of manufacture of claim 1, wherein the instructions to render the one or more nodes of the graphical layout to graphically represent manipulation operations, comprise instructions to:
rearrange the one or more nodes of the graphical layout.

4. The article of manufacture of claim 1, wherein the instructions to render the one or more nodes of the graphical layout to graphically represent manipulation operations, comprise instructions to:
establish one or more new connections to represent the change in connections between the nodes.

5. The article of manufacture of claim 1, wherein the attribute comprises a characteristic or a key figure.

6. The article of manufacture of claim 1, wherein the manipulation operation for changing an attribute comprises choosing an attribute from a plurality of attributes.

7. The article of manufacture of claim 1, wherein manipulation operations further comprises editing a name of a node.

8. A computerized method for manipulation of elements of a graphical layout, the method comprising:
displaying on a user interface a graphical layout comprising nodes and connections as a representation of data in a data source; and
rendering one or more nodes of the graphical layout to graphically represent manipulation operations performed by a user on one or more nodes of the graphical layout to create a new data source, wherein the manipulation operations comprise at least one of:
selection of one or more nodes, changing an attribute, and changing connections between the nodes.

9. The method of claim 8, wherein rendering the one or more nodes of the graphical layout to graphically represent manipulation operations, comprises:
rendering the one or more nodes of the graphical layout to graphically represent the one or more manipulation operations with unique graphical characteristics represented by a color, a symbol, or a combination of the color and symbol.

10. The method of claim 8, wherein rendering the one or more nodes of the graphical layout to graphically represent manipulation operations, comprises:
rearranging the one or more nodes of the graphical layout.

11. The method of claim 8, wherein rendering the one or more nodes of the graphical layout to graphically represent manipulation operations, comprises:
establishing one or more new connections to represent the change in connections between the nodes.

12. The method of claim 8, wherein the attribute comprises a characteristic and a key figure.

13. The method of claim 8, wherein the manipulation operation for changing an attribute comprises choosing an attribute from a plurality of attributes.

14. The method of claim 8, wherein manipulation operations further comprises editing a name of a node.

15. A computer system for manipulation of elements of a graphical layout, comprising:
a computer memory to store program code; and
a processor to execute the program code to:
display on a user interface a graphical layout comprising nodes and connections as a representation of data in a data source; and
render one or more nodes of the graphical layout to graphically represent manipulation operations performed by a user on one or more nodes of the graphical layout to create a new data source, wherein the manipulation operations comprise at least one of:
selection of one or more nodes, changing an attribute, and changing connections between the nodes.

16. The system of claim 15, wherein the instructions to render the one or more nodes of the graphical layout to graphically represent manipulation operations, comprise instructions to:
render the one or more nodes of the graphical layout to graphically represent the one or more manipulation operations with unique graphical characteristics represented by a color, a symbol, or a combination of the color and symbol.

17. The system of claim 15, wherein the instructions to render the one or more nodes of the graphical layout to graphically represent manipulation operations, comprise instructions to:
rearrange the one or more nodes of the graphical layout.

18. The system of claim 15, wherein the attribute comprises a characteristic and a key figure.

19. The system of claim 15, wherein the manipulation operation for changing an attribute comprises choosing an attribute from a plurality of attributes.

20. The system of claim 15, wherein manipulation operations further comprises editing a name of a node.
